(19) United States
(12) Patent Application Publication
(10) Pub. No.: US 2019/0321947 A1
(43) Pub. Date: Oct. 24, 2019

(54) SCRATCHLESS TOOL

(71) Applicant: ROBERT C TAGER, REDWOOD CITY, CA (US)

(72) Inventor: ROBERT C TAGER, REDWOOD CITY, CA (US)

(73) Assignee: ROBERT C TAGER, REDWOOD CITY, CA (US)

(21) Appl. No.: 16/386,233

(22) Filed: Apr. 16, 2019

Related U.S. Application Data
(60) Provisional application No. 62/659,638, filed on Apr. 18, 2018.

(51) Int. Cl. B25B 13/58; B25B 7/02

(52) U.S. Cl. CPC B25B 13/58; B25B 13/5025; B25B 7/02

(57) ABSTRACT

The existing gripping tool are made of or covered with non scratchable material to prevent damage to articles on which they are being used. The scratchless tool may be modified either partially or fully to accommodate a softer surface made of non scratchable material. They can either be co-moulded or attached or bonded or inserted to the existing metal tool during manufacturing or use.

### CROSS REFERENCE TO RELATED APPLICATION

This application claims priority to U.S. Provisional application 62/659,638 filed on 18 Apr. 2018. The disclosure is hereby incorporated by this reference in its entirety for all of its teachings.

### FIELD OF INVENTION

The present invention is generally directed to scratchless tool to minimize damage to finished fixtures or parts of the fixtures that have a very fine surface and get easily scratched.

### BACKGROUND

The hardware tool that are available in the market are made up of hard metal to be robust and be strong for plumbing or other activities. The faucets, car parts etc., are made up of light material and are delicate in nature. The problem that professionals face is while working on this equipment and parts they tend to scratch the surface or break the surface as the tool are hard and the equipment are of lighter material. There is a need for balancing the task to be done well and not damage the surface of expensive equipment.

### SUMMARY

The present invention is apparatus and a method to make a scratchless tool by adding a non scratchable material as an insert to existing tool or making a tool with non scratchable material. In one embodiment, a part of the tool is made up of a hard and strong material which is a non scratchable material. In another embodiment, the entire tool may be coated with non scratchable material to prevent damage to the fixture it is being used on. In every embodiment the tool size and shape conforms to industry standard. In one embodiment, hand held tool, gripping tool, insertable tool parts for semi or fully mechanized tool heads, mechanized tool is made up of non scratchable material. In one embodiment, for example a plier tip may be co-moulded or coated with a non scratchable material. In another embodiment, the jaw or the part of the tool that holds a fixture for either tightening or loosening is made up of the non scratchable surface. In yet another embodiment, the jaw or gripping part is covered with a non scratchable surface to prevent damage to either the fixtures or part of the fixture.

In another embodiment a tool having an upper jaw and a lower jaw is covered with a tool with non scratchable material. In another embodiment, a gripping tool is made into a scratchless tool by inserting a non scratchable material as an insert. In one embodiment, the insert made of non scratchable material is either bonded, molded or covered on to the surface of the tool that performs a gripping action while installing, removing, repairing a fixture. In another embodiment, the fixture is a plumbing fixture, light fixture or any other fixture.

The product and method of using the product disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A shows an adjustable plier with various parts. FIG. 1B shows an insert that would prevent the scratch introduced by the metal tool. FIG. 1C shows placing the insert in the tool. FIG. 1D shows the insert placed in the tool and ready to be used.

FIG. 2A shows a regular monkey wrench or straight pipe wrench and FIG. 2B is a view of a monkey wrench with a non scratchable insert.

FIG. 3A shows an adjustable wrench with metal jaws and FIG. 3B is a view of the adjustable wrench with a non scratchable insert.

FIG. 4A shows an adjustable gripping plier, FIG. 4B shows adjustable gripping plier with a non scratchable insert.

FIG. 5 shows plumbing plier with a non scratchable insert.

FIG. 6 shows a plier with a non scratchable insert, which may be modified to accommodate functionality.

FIG. 7 shows a different type of plier with a non scratchable insert.

FIG. 8 shows a faucet set with thin cover coating.

FIGS. 9A and 9B shows a prior art of wash basin tap with soft screws for installation.

FIG. 10A shows a new faucet fastening core that is not damaged, FIG. 10B shows when regular tool are used how it can get damaged, FIG. 10C shows when a tool with a non scratchable insert is used it looks new without damage.

FIG. 11 is an adjustable wrench showing an object being tightened without the a non scratchable insert.

FIG. 12 shows a non scratchable insert fixed inside the adjustable wrench.

FIG. 13A is a prior art picture of a wide jawed cutting plier.

FIG. 13B shows a non scratchable insert fixed at inner grooves of wide jawed cutting plier.

FIG. 14 shows another method of inserting a non scratchable insert into any gripping device.

Other features of the present embodiments will be apparent from accompanying the detailed description that follows.

### DETAILED DESCRIPTION

The present invention is directed to create a scratchless tool by using non scratchable material to either cover parts of the tool or fully covers the entire tool as a special structural change. The non scratchable material can be used as an insert for the existing industry tool. They may be either bonded, moulded or pinned to the inner surface of the serrated parts of the tool that are used for gripping, fastening or tightening. The method of making a scratchless tool is also described using non scratchable material. This non scratchable material to make the scratchless tool may either be co-moulded or entirely cover the tool or fully made of this material. The scratchless tool are not limited to just hand held tool, they may be inserts for other exchangeable parts for mechanized or non-mechanized tool for fastening or tightening action on articles. The entire metal ratchet may be coated with non-scratchable material. The non scratchable material needs to soft, non-conductive, strong, non-slip and conducive to mould into different shapes. The non-scratchable material needs to meet industrial standards for hardness, shape and tolerance requirements. The non-scratchable material may be polymer, resin, rubber, silicon or any other industrial scale suitable material that is either synthetic or natural. Examples of various types of tool are described below with different figure descriptions. The list is not limited to an adjustable plier, monkey wrench, adjustable wrench, adjustable gripping plier, plumbing plier, different type of plier, wide jawed plier and other gripping tool, fastening tool and repair tool.

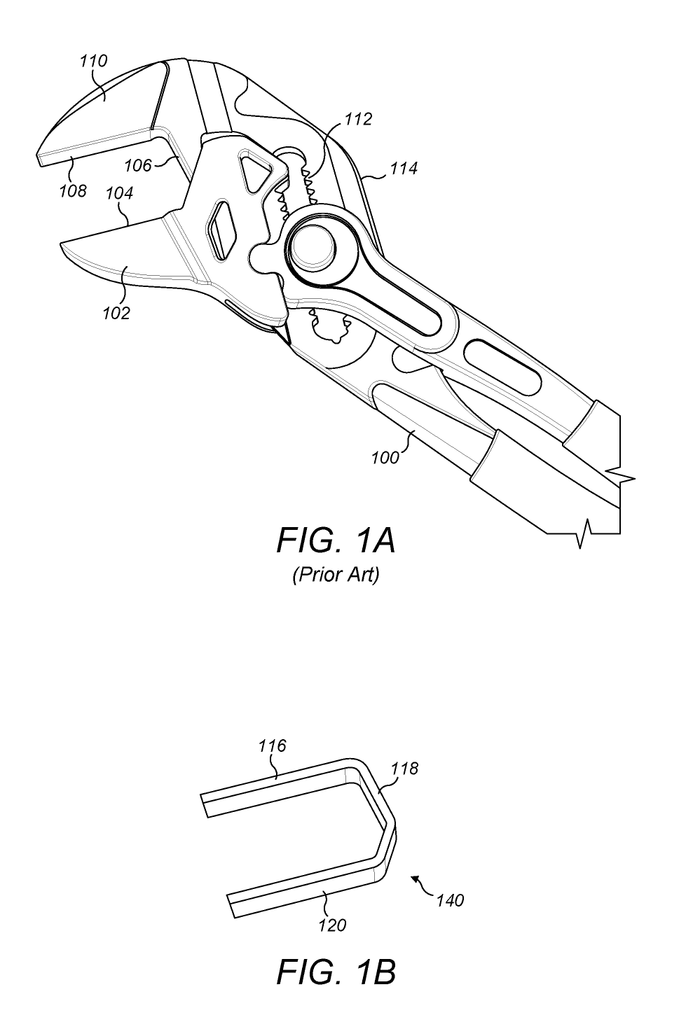

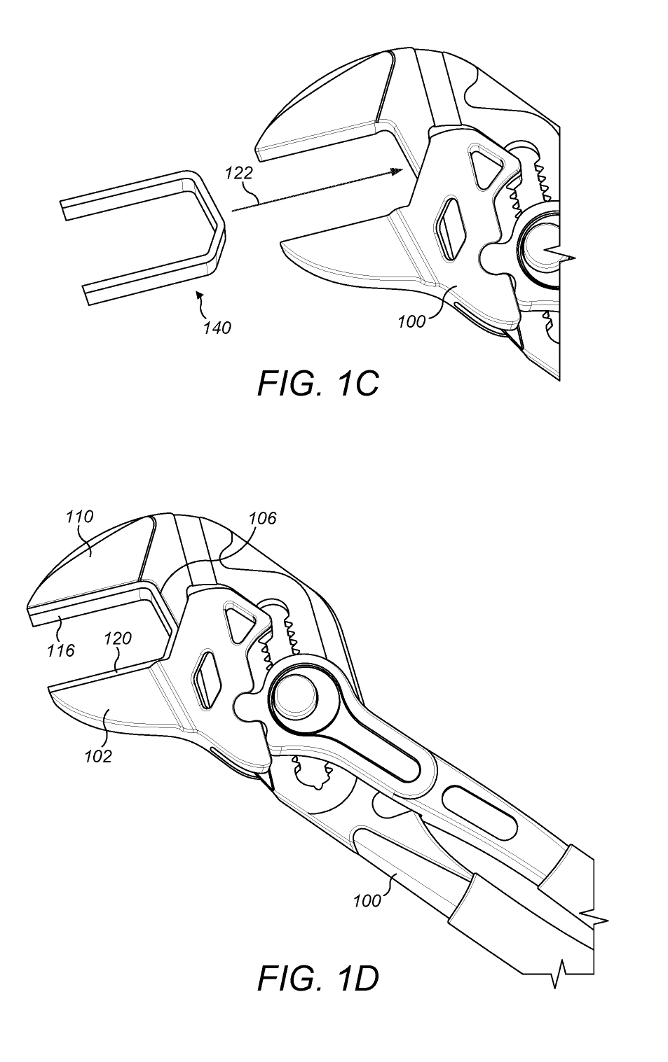

FIG. 1A shows an adjustable plier 100 with various parts. These series of figures are one embodiment of showing a method for inserting non scratchable material as an insert into any tool. FIG. 1A shows a worm screw 112 and its case 114 that is used for expanding the lower jaw 102 and fixed jaw 110. A gripping tool such as this adjustable plier has a first jaw (movable) and a second jaw (fixed), wherein the first jaw has a upper top surface and a upper inner surface 108, and the second jaw having a lower top surface and an lower inner surface 104 with a connecting surface 106, wherein the upper inner surface and the lower inner surface have a modified surface; and a non scratchable material insert to be placed on the upper inner surface and the lower inner surface to modify the existing tool to become the scratchless tool and prevent damage to any surface. FIG. 1B shows non scratchable material insert that would prevent the scratch introduced by the metal tool. The u-shaped insert is just shown as an example. It can be modified to suit the shape of the tool. The said shown insert has four parts 116, 118, 140 and 120 to fit the said adjustable plier. FIG. 1C shows placing 122 the u-shaped insert made of non scratchable material in the adjustable plier to fit the inner surface of both the jaws. FIG. 1D shows the u-shaped insert placed in the adjustable plier and ready to be used. If the user deems necessary to remove the parts 118 and 140 and just insert parts 116 and 120 to suit the function of the tool the insert may be made with removable middle parts to the user can cut out the middle part and bond or fix the insert to the said tool. The middle part 118 and 140 may also be made of expandable material so as the jaws when opened, the insert lends itself to be stretched to allow the tool to expand to perform the work on the object. The modified insert may be used with said tool or any other tool described below.

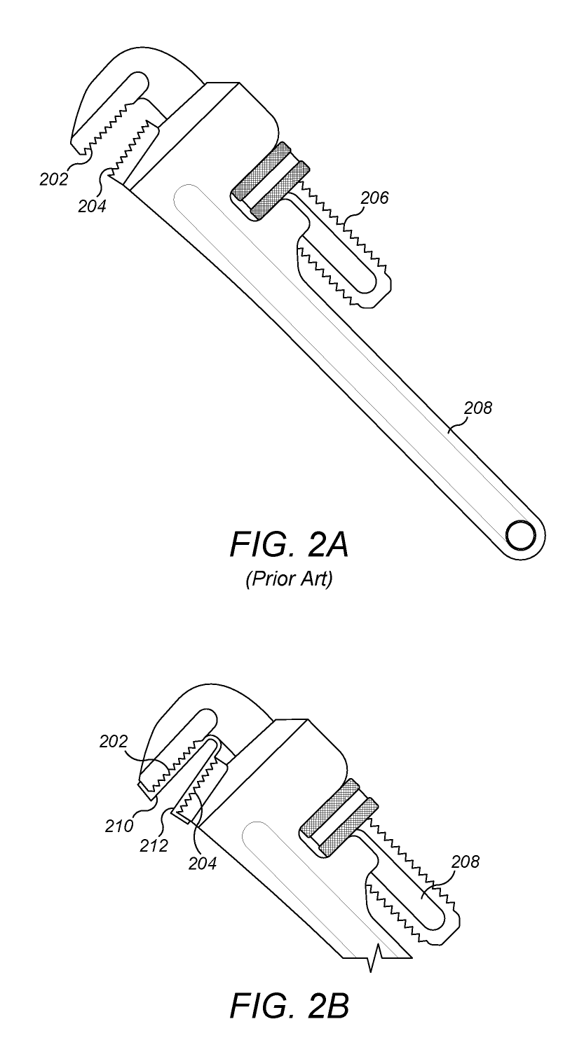

FIG. 2A shows a regular monkey wrench or straight pipe wrench 208 with a fixed jaw 204 and a movable jaw 202 with adjustable screw 206. FIG. 2B is a view of a monkey wrench with a non scratchable inserts 210 and 212. They are designed to fit the expansion region and the flat region of the fixed jaw and the adjustable jaw.

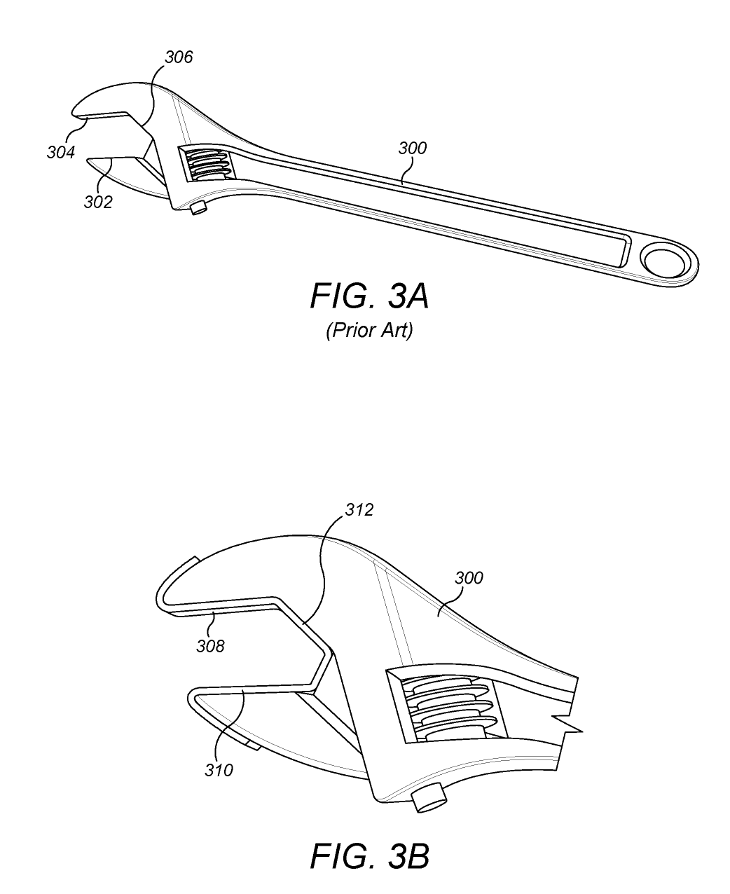

FIG. 3A shows an adjustable wrench 300 with metal jaws 304 and 302 and a cavity area 306 and FIG. 3B is a view of the adjustable wrench with a non scratchable insert.

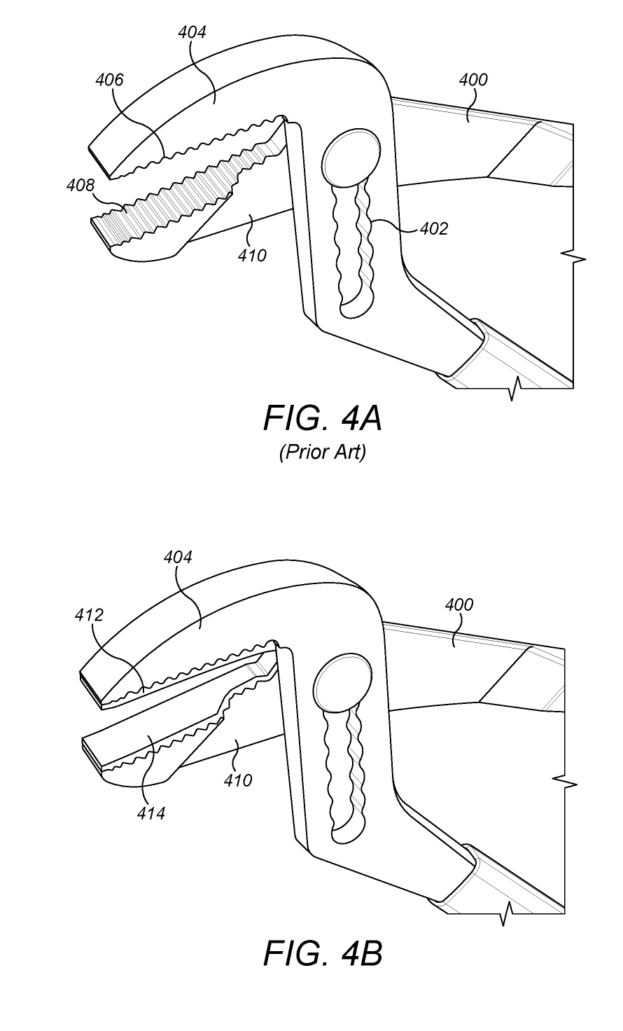

FIG. 4A shows an existing adjustable gripping plier 400. The adjustable gripping plier has a section 402 that allows the user to reduce the distance between two jaws 404 and 410. The upper jaw has an inner surface 406 and the lower jaw has an inner surface 408 that is serrated. FIG. 4B shows adjustable gripping plier with a non scratchable insert. The lower jaw has an insert 414 and the upper jaw has an insert 412. Both insert cover the entire expansion region and make sure no serrated area is exposed. Both the surfaces of the insert can be either flat or serrated to fit the tool or the work.

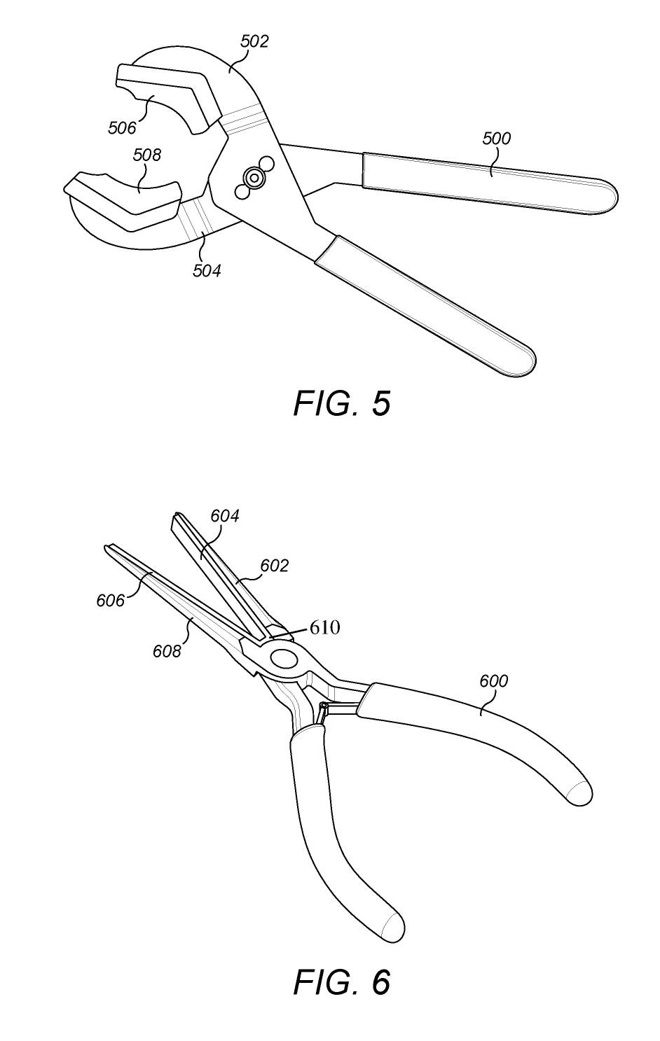

FIG. 5 shows plumbing plier 500 with a non scratchable insert. The two heads 502 and 504 of the plumbing plier has a coating of non scratchable surface 506 and 508. Specifically these days the articles are coated either with plastic, very thin layer of stainless steel, chrome or other surface. Either way when the professionals either install or remove an expensive form of article/object they scratch the surface. To prevent this, scratchless tool is the ideal solution.

FIG. 6 show a plier 600 with a non scratchable insert. The plier has two elongated prongs 602 and 608. Usually the prongs have small metal serrated teeth and for the specific purpose of use would damage the surface of the article they are used on. Hence a scratchless material can be used as an insert 604 and 606. A rubber material can be bonded to the surface and the unfinished surface of the rubber material would serve as a scratchless insert. The middle surface 610 of the insert that connects the two sides of the prongs may be made of different material that is thinner than the prongs or the user can remove it by cutting out the portion before or after bonding the insert to the tool.

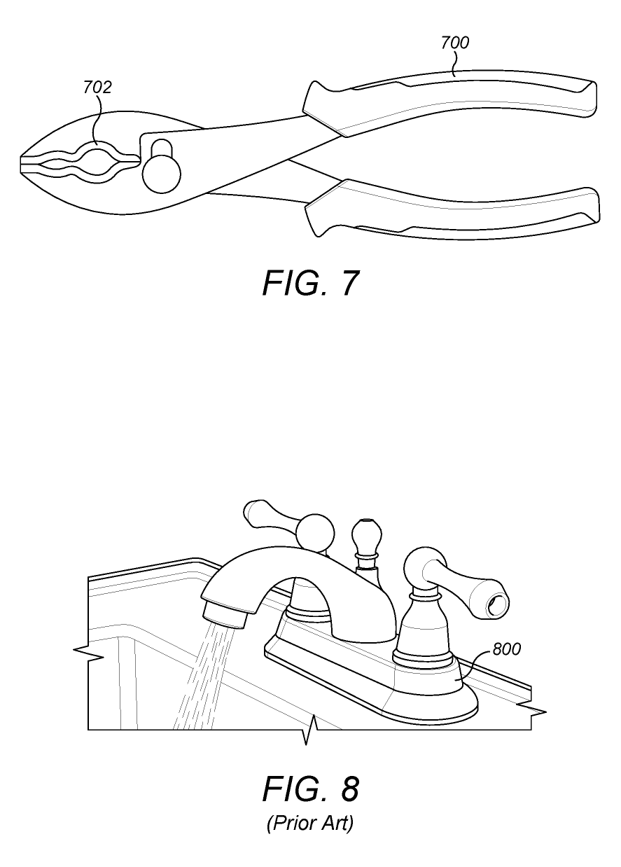

FIG. 7 shows a different type of plier 700 with a non scratchable insert 702. The different type of plier is a fitter's and assembler's hand tool. FIG. 7 shows that the entire inner surface of different type of plier is bonded, coated or fixed with a non scratchable insert. In one embodiment the entire tool can be made of non scratchable material that is hard enough to handle the torque and soft enough not to scratch.

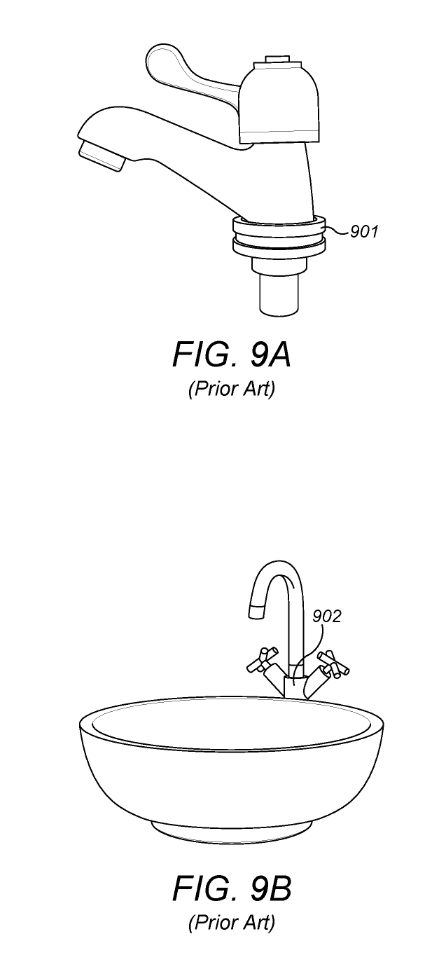

FIG. 8 shows a faucet set with thin cover coating. These coating can be very thin and easily damaged and spoil the aesthetic and appearance of the fixture 800. The faucet and other fixtures can be coated with fine materials and the international standard of faucet electroplating thickness is 8 microns, the best can reach 12 micron. Most tools exert a lot of pressure while installation and produce friction which can damage such a fine coating easily. FIGS. 9A and 9B shows a prior art of wash basin tap with soft screws 901 and 902 for installation.

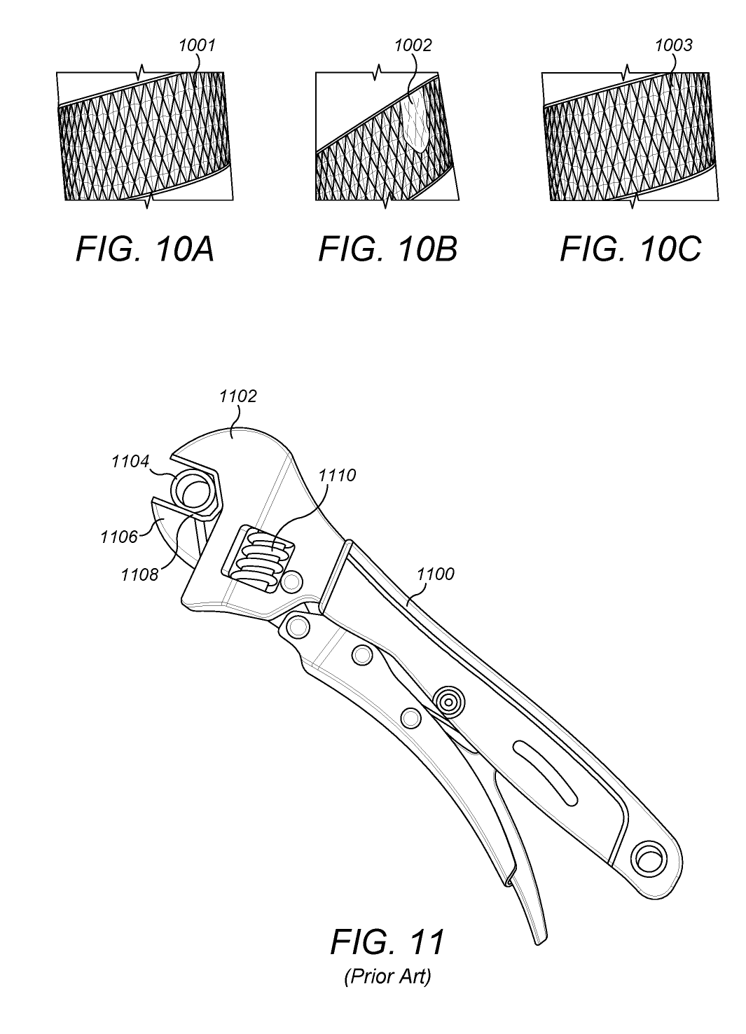

FIG. 10 shows an example of the new faucet fastening core 1001 that is new. Typically these may be coated with polished chrome, nickel, epoxy coating and combination of those. Some may have very thin gold coating on the outside as well. FIG. 10b shows that when regular tool are used for installation or fastening the surface can get damaged 1002. Once damaged it not only looks bad but future repair work, taking the fixture out or replacing the part becomes an issue. FIG. 10C shows that when scratchless tools are used the surface 1003 is not damaged.

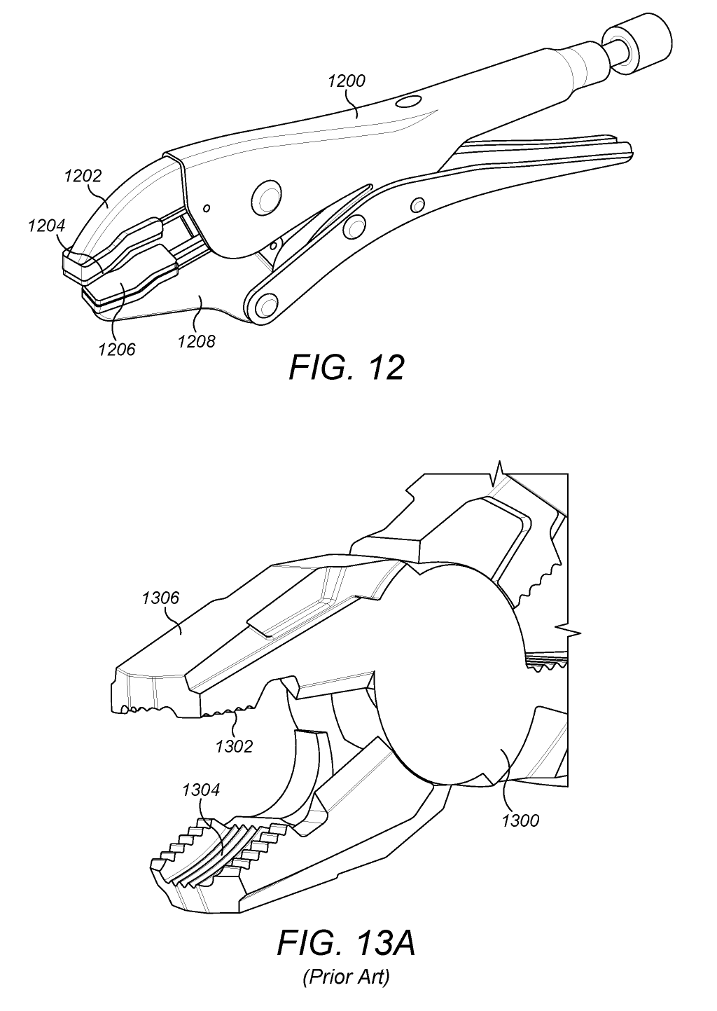

FIG. 11 shows a prior of existing and adjustable wrench 1100 with an adjustable handle and a fixed handle. The fixed jaw 1102 does not move wherein the adjustable jaw 1106 moves up and down when the screw 1110 is rotated. This figure shows an example of a object 1104 being fitted for some plumbing work. FIG. 12 shows an insert fixed inside the adjustable wrench 1200 similar to 1100. The fixed jaw 1202 is covered using a tight fit cover 1204 made up of a non scratchable material and fits on three sides of the jaws. The adjustable jaw 1208 is covered with a tight fit cover 1206. This prevents the slippage of the non scratchable material from the adjustable wrench while being used for various activities. Once the user decides that they are going to expand the tool width by moving the two jaws the insert may either expand with the jaws or a slight serration in the middle of the insert may enable the insert to split and just cover the two jaws.

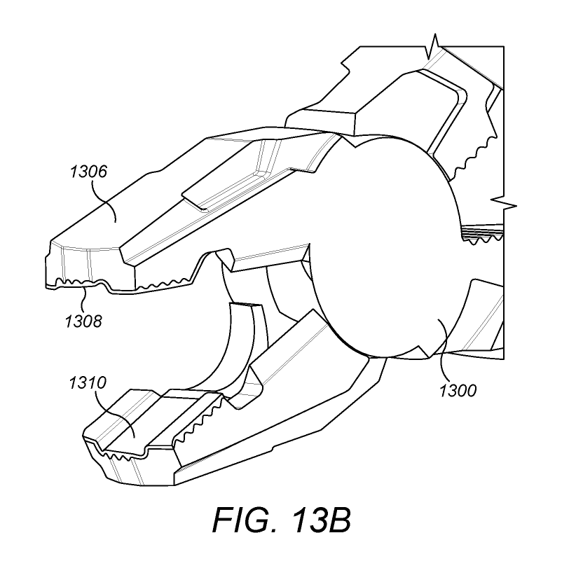

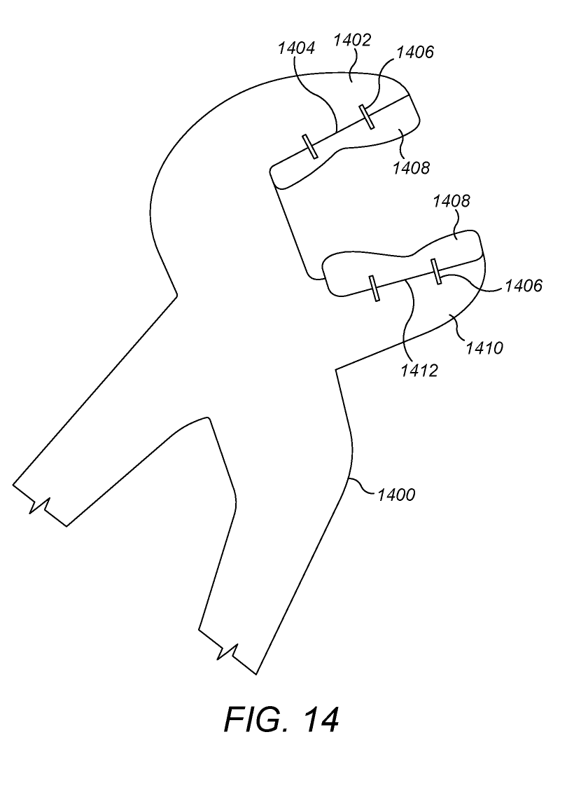

FIG. 13A is a prior art picture of a wide jawed cutting plier 1300 with two different serrated surfaces 1302 and 1304. The surface 1302 has horizontal serrations and surface 1304 has longitudinal surface. The jaw 1306 houses both serrated surface on the inside of the wide jawed cutting plier. FIG. 13B shows the wide jawed cutting plier 1300 with scratchless surface 1308 and 1310. The material that is attached or bonded to the 1302 and 1304 surface is scratch proof. Since the groves are in different directions the material 1308 and 1310 has to be contoured well to fit the groves. The scratch proof material has to be of the right thickness to the effectiveness of the grove for gripping or effort during use is not diminished. The surface of the material may also be grooved to fit the contour of the wide jawed cutting plier or it can be flat. In another embodiment, the wide jawed cutting plier may use the method of fixing the insert by embedding the insert surface using two pins (as shown in FIG. 14). The pin holes may be drilled in the serrated inner jaw surfaces 1302 and 1304. The insert, which removable after use is either flat or serrated to match the serration of the tool. This removable insert is then placed on the inner surface of the jaws using the pin into the hole. The insert material may not be applied to the cutter portion of the tool.

FIG. 14 shows another method of inserting the scratch proof insert into any gripping device. The above mentioned inserts were either wrapped around or bonded to the device. This method of inserting shows that a hole may be drilled into the device and two pin type of fixture can be mounted on the non scratchable surface material which can then be fixed to the device on the inner surface of the device. This would enable it to stable during use and modified surface on the tool would not scratch the surface of finely finished fixtures. In this FIG. 14 a wrench 1400 has two jaws, upper jaw 1402 and lower jaw 1410. The inner surface 1404 of the upper jaw 1402 has two pins 1406 from the non scratchable insert 1408. The pin 1406 is part of the non scratchable material 1408 and moulded as one part or can be a separate part which could be repeatedly used for inserting other non scratchable surfaces. The insert in this manner may also be bonded to the surface after it has been placed with the pin.

In addition, it will be appreciated that the various embodiments, materials, and compositions can be interchangeable used in the current embodiments and various combinations of the article of use. Accordingly, the specification and drawings are to be regarded in an illustrative rather than a restrictive sense.

What is claimed is:

1. A scratchless tool, comprising:
A gripping tool having a first jaw and a second jaw, wherein the first jaw has a upper top surface and a upper inner surface, and the second jaw having a lower top surface and an lower inner surface, wherein the upper inner surface and the lower inner surface have a modified surface; and
A non scratchable material insert to be placed on the upper inner surface and the lower inner surface to modify the existing tool to become the scratchless tool and prevent damage to any surface.

2. The scratchless tool of claim 1, wherein the non scratchable material insert is made a part of the gripping tool at least by using one of molding, structurally incorporating to the gripping tool, bonding, and making the entire said gripping tool with the non scratchable material.

3. The scratchless tool of claim 2, wherein the non scratchable material is at least one of rubber, silicon, any other soft material or a non-slip material.

4. The scratchless tool of claim 1, wherein the gripping tool is at least one of an adjustable plier, monkey wrench, adjustable wrench, adjustable gripping plier, plumbing plier, a different type of plier, wide jawed plier and other gripping tool.

5. A scratchless adjustable plier, comprising:
An adjustable plier having a first jaw and a second jaw, wherein the first jaw that is movable has a upper top surface and a upper inner surface, and the second jaw that is fixed having a lower top surface and an lower inner surface, wherein the upper inner surface and the lower inner surface have a modified surface; and
A non scratchable material insert to be placed on the upper inner surface and the lower inner surface to modify the existing tool to become the scratchless tool and prevent damage to any surface.

6. The scratchless adjustable plier of claim 5, wherein the modified surface is serrated or non-serrated.

7. The scratchless adjustable plier of claim 5, wherein the non scratchable material is at least one of a polymer, resin, rubber, silicon or any other industrial scale suitable material that is either synthetic or natural.

8. A scratchless wrench, comprising:
An adjustable wrench having a first jaw and a second jaw, wherein the first jaw that is movable has a upper top surface and a upper inner surface, and the second jaw that is fixed having a lower top surface and an lower inner surface, wherein the upper inner surface and the lower inner surface have a modified surface; and
A non scratchable material insert to be placed on the upper inner surface and the lower inner surface to modify the existing tool to become the scratchless tool and prevent damage to any surface.

9. The scratchless adjustable wrench of claim 8, wherein the modified surface is serrated or non-serrated.

10. The scratchless adjustable wrench of claim 8, wherein the non scratchable material is at least one of a polymer, resin, rubber, silicon or any other industrial scale suitable material that is either synthetic or natural.
